(19) United States
(12) Patent Application Publication
(10) Pub. No.: US 2019/0180566 A1
(43) Pub. Date: Jun. 13, 2019

(54) NOVEL PAI GOW CARD GAME WITH ASYMMETRIC CARD DISTRIBUTION

(71) Applicant: Jeffery Hwang, Henderson, NV (US)

(72) Inventor: Jeffery Hwang, Henderson, NV (US)

(21) Appl. No.: 15/836,380

(22) Filed: Dec. 8, 2017

(51) Int. Cl. G07F 17/32

(52) U.S. Cl. CPC G07F 17/3267; G07F 17/3288; G07F 17/3293; G07F 17/3251

(57) ABSTRACT

A competitive playing card game is based on Pai Gow poker, except that player position playing cards are provided in two segments totaling seven random playing cards, and the dealer position receives eight random playing cards. After placing an ante and receiving a first segment of random playing cards totaling less than 7 cards, a play wager must be placed for the player position to receive additional cards to complete a seven-card hand. A player position best five-card hand poker rank can receive payouts based on achievements against a paytable for poker ranks above a minimum threshold.

### BACKGROUND OF THE INVENTION

### 1. Field of the Invention

The present invention relates to the field of competitive playing card activities, particularly casino-type wagering games, and more particularly to Pai Gow poker type games.

### 2. Background of the Art

Although the game of Pai Gow Poker, frequently referred to as Asian Poker and double hand poker, has been around for many years, it has not received widespread play in gambling establishments throughout the United States. As is well known in the art, the game is played with either tiles or with a standard deck of 52 playing cards with one Joker added. In some versions of the game, a joker is utilized to represent only a limited number of cards such as an Ace or as part of a Straight or Flush. Rankings in Pai Gow Poker are substantially the same as rankings in other types of poker games.

Pai Gow Poker is typically played in a casino at a table much like that used for Blackjack, casino table poker variants, Baccarat or the like, except that there is typically one less player position. That is, there is a dealer position and six player positions equally spaced around the perimeter of the table. The game is limited to six player hands and a dealer hand, using 49 cards, and leaving four remaining cards. At each player position, there are normally markings or indicia for setting the dealer's and players' high and low hands (explained hereinafter) and a spot for each player to place his or her Ante or Bet wager.

The game is typically started by each player placing a bet. The dealer then deals seven cards to himself and seven cards to each of the six player positions, using 49 of the 53 cards in the playing card deck. Each player, including the dealer, then forms two hands from the holdings of seven cards. One hand, referred to as the low hand, consists of two of the dealt cards. The other hand, referred to as the high hand, consists of the remaining five cards that were dealt to that player. The high hand must be higher in poker rank than the low hand. If the hand is a Pai Gow (no ranked hands possible higher then an Ace high), then the highest ranked card must be present in the high hand.

The only requirement in forming or setting the high and low hands is that the low hand must be of a lower rank than the high hand. The ranking of the hands is similar to traditional poker with the exception as pointed out above that the joker can be used to represent an ace or to represent any one card of either a straight or a flush. Thus, the highest possible hand is five aces.

If the player's low hand and high hand are both higher in rank than the low and high hand of the dealer or banker, the player is a winner and the banker loses. However, if both of the dealer's or banker's hands are higher than the player's, the player is a loser and the banker wins. If only one of either of the player's high or low hands tie or lose to the comparable dealer's hand, the round is considered a push. Under some house rules, the banker's hand is normally considered to be the winner in the event of a tie in both hands or even one hand, although this latter rule is rarely in play.

If the player's low hand is of a higher rank than the banker's low hand but the player's high hand is of a lower rank than the banker's high hand, neither wins and there is considered to be a push. Similarly, a push exists when a player's low hand is of a lower rank than the banker's low hand and the player's high hand is of a higher rank of the banker's high hand. There is, therefore, no winner when a push exists.

In some casinos, the banker and the dealer are one and the same and is employed by the casino. The dealer is employed by the casino and deals the cards but is also a player. More frequently, however, the players are given an option, in turn, to be the banker and each of the other players would then play against the banker/player. (The banker is the dealer or player who is responsible for paying or collecting from each of the players.) When this is done, the house, that is, the establishment operating the game, takes a commission by way of a percentage on all winning wagers or is paid a flat commission per round or per hour.

The house also takes a commission or ante from each player when they win. The commission may be about 1% of the wager, such as taking $0.25 from a $25 wager, $0.50 from a $25-50 wager, and $0.75 for a wager between $51-75. There are numerous ways in which the house can collect on a player-banked game.

There are a few known special bonuses that can be won at Pai Gow poker. In some locations, there may be bonuses for specially ranked hands, such as a Pair of Aces and four of a kind or higher, and a special bonus or jackpot for a pair of Aces as the low hand and a straight flush or royal flush for the high hand.

U.S. Pat. No. 6,491,302 describes a method of playing a Pai Gow poker game in which, in addition to the usual seven cards dealt to each player and the dealer, a single player tiebreaker card is dealt for all players and a single dealer tiebreaker card is dealt to the dealer. The ante bet of each player is then paid off for winning and losing hands in the usual manner of a Pai Gow game. However, with push hands (where only one of the two-card hand and five-card hand of the player has a higher poker rank than the respective two-card hand and five-card hand of the dealer), the winner is determined by the higher value of the player and dealer tiebreaker cards so that no push bets occur.

U.S. Pat. No. 5,931,472 describes an improved game of Pai Gow is set forth which includes offering the player an optional bonus wager. Should the tiles of the Player's hand match any predetermined bonus outcome tile combination, the Player receives a reward for their bonus wager regardless of whether or not the Player has won their hand according to the rules of Pai Gow.

U.S. Pat. No. 6,007,424 describes a method, device and system for playing a new game of Pai Gow Poker. The method includes dealing seven cards to the dealer and to each player, the players and dealer each (from those seven cards) assembling a five card high hand and a two card low hand. For the player to win their wager, both the player's high and low hands must outrank the dealer's hands according to the ranking of hands of Poker. For a push the player's high hand must have a higher ranking the dealer's and be Jacks or better. All other hands are losses. The method provides for greater payoffs if the player has one of a plurality of payoff qualifying holdings. The device includes a processor programmed to play the game according to the method. The system provides for linking devices to amass a progressive jackpot payout should the player obtain a qualifying hand.

U.S. Pat. No. 6,070,876 describes an improved game of Pai Gow that includes offering the player an optional bonus wager. Should the tiles of the Player's hand match any predetermined bonus outcome tile combination, the Player receives a reward for their bonus wager regardless of whether or not the Player has won their hand according to the rules of Pai Gow. The game also provides the option to make a tie wager.

U.S. Pat. No. 6,113,103 teaches a variation of Pai Gow Poker known as Dragon Poker. A player posts a wager and is dealt a first four of seven cards face down. A bank is dealt a first a first four of seven cards, three of which are dealt face up. The player is then given an option of surrendering and receiving a return of a portion of the wager. With the surrender, the player's participation in the game is at an end. The player who does not surrender is a surviving player who may be given an option of increasing the wager. The surviving player and the bank are each dealt three additional cards to enable formation of a player back hand and a player front hand and formation of a bank back hand and a bank front hand. After the hands are formed, the wager is resolved.

U.S. Pat. No. 5,863,041 (Boylan) describes a method of playing a Pai Gow poker wagering game in which an Ante bet is initially wagered and a Bonus bet is also wagered by at least one player. Seven cards are then dealt to each player and the dealer, and arranged into a two-card low hand and a five-card high hand. The ante bet of each player is then paid off to in the usual manner for Pai Gow poker. Thereafter, a best five out of seven card poker hand is arranged by the dealer for each player from the seven cards initially dealt to the player, and the bonus bet is paid off if the best poker hand has a poker rank equal to or better than a first predetermined rank (e.g., a straight) but less than a second predetermined rank (e.g., a royal flush or five-of-a-kind in a wild card game). Next, the dealer determines whether the best poker hand of each player has a poker rank better than or equal to the second predetermined rank so that an auxiliary game of chance, such as rolling three dice, is then played to determine whether the bonus bet is paid off at a first payoff rate where the player is a loser or at a second payoff higher than the first payoff rate when the player is a winner in an auxiliary game. In addition, the dealer then determines whether each player has made a bonus bet of a predetermined minimum, (exceeding the betting minimum) which is then paid off if any other player has a best poker hand equal to or better than a third predetermined rank (four of a kind) in an event called an “envy” bet.

U.S. Pat. No. 6,270,078 (Leone et al.) describes version of the game of Pai Gow Poker that allows a player to bet against the house and/or to bet against the other players. In addition to the conventional betting spot for placing an optional bet against the banker and/or other players, an additional betting spot is located in front of each of the players that allows the player to optionally bet against the house. This can be done whether or not the house is the banker. Thus, even if a fellow player has been designated as the banker, each other player can still choose to play against only the house. Each player can, of course, play against his or her fellow player/banker but is not required to do so. Each player can play against the house, against his or her fellow player/banker, against neither or against both.

U.S. Pat. No. 5,584,486 describes a method of playing a game of Pai Gow poker comprising: a player placing a first wager; a player placing a jackpot bet; and a dealer dealing seven cards to himself and to said player. Each player arranges his/her cards into a low hand including two of said seven cards and a high hand including five of said seven cards. Each player evaluates the cards and determines whether the cards comprise a predetermined jackpot card holding of a low hand pair and a high hand of one of (i) four aces and the joker, (ii) a royal flush, (iii) a straight flush, (iv) four of a kind, (v) full house, (vi) flush or (vii) straight. Players are paid a jackpot amount if the player has a jackpot holding. The winner of the first wager is determined by comparing a low hand of said dealer to said low hand of said player and a high hand of said dealer to said high hand of said player.

U.S. Pat. No. 5,580,081 describes a method of eliminating a push in a game of Pai Gow Poker where a player and a banker are each dealt seven cards from a standard deck of 52 playing cards plus a Joker, the player and the banker each forming a High Hand and a Low hand from the dealt cards. The method describes the steps of: assigning a numerical value to each card; comparing a card in a player's hand to a corresponding card in a banker's hand; and designating a winner based upon whether or not the corresponding cards have total numerical values that are either both odd or both even.

U.S. Pat. No. 6,422,564 describes a two card poker game against a dealer in which a two-card dealer hand used in play is created from discarded cards from player hands. Players are initially dealt five cards each, and are required to discard the highest card. The pool of discarded high cards is used to form the dealer's two-card poker hand. The game is played with a lower numerical ranking portion of a deck comprising the card ranks of Two through Eight of a typical fifty-two card Poker deck. The game method includes the steps of each player placing an initial wager to participate in the game. If player positions are not occupied, the dealer retrieves the highest numerical ranking card from hands dealt to unoccupied positions and places those cards into the designated high card area in front of that unoccupied player position. Next, players decide which two cards of their remaining four cards they wish to hold and use to build their mandatory two card hand. Players must place the two cards into an appropriate depicted hold card area in front of that player position. Players must then discard the remaining two cards into an appropriate depicted discard area in front of that player position. Each player then has the benefit of a two card hand. The dealer chooses the house's two card hand from the pool of high cards discarded by the players and placed in the designated area. The dealer indicates the choices by placing an indicator apparatus onto each of the two cards chosen. The dealer informs the players of the houses two card hand. Finally all cards in each occupied player positions are shown, and the payouts to the winning hands and the collections of the losing hands wagers are resolved. The players are playing against the dealer and not against each other.

U.S. Pat. Nos. 6,481,719 and 6,012,719 describe a card game that combines the play of Blackjack (“21”) with a 3-card Poker wager or side bet (“21+3”). Each player places a basic Blackjack wager and an optional three-card poker wager before the cards are dealt. Each player is then dealt a card with the dealer receiving a face-up card. Each player is then dealt a second card. At this point, the outcome of each three-card poker hand is determined, where a three-card poker hand consists of the two-card hand dealt to that player and the dealer's face-up card. After settling the Poker wagers, the game of Blackjack continues in a typical fashion. The invention advantageously retains all the features and advantages of Blackjack as well as provides an additional opportunity to wager on a hand of three-card poker, without interfering with the card dealing sequence, for enhanced player anticipation and enjoyment.

Another known modification of the Pai Gow poker game has been played at “Harvey's Resort and Casino” in Tahoe, Nev. In this modified game, a bonus bet is made (in addition to the ante bet in the usual game for the five-card hand and two-card hand ranks to be compared with those of the dealer). This bonus bet is won at odds if the player has any five cards (best five-card poker hand of the seven cards dealt) which together rank above a straight (with the odds increasing for increasingly ranked hands). In addition, if a player makes a bonus bet above $5 (× the minimum), that player can additionally win a predetermined payoff if any other player has any best five-card hand forms a poker rank above four of a kind (with the payoff increasing for increasingly ranked hands). This type of payout is referred to in the industry as an “envy bonus”. Envy bonuses are typically won on another player's hand, not on one's own hand.

U.S. Pat. No. 7,905,770 (Snow) discloses a method of playing a Pai Gow Poker wagering card game is disclosed. The method includes the steps of: a) a player placing a wager on a Pai Gow Poker game, b) players placing a second wager against a pay table on a separate poker-type game that uses each player's best five-card hands from each player, c) dealing seven-card hands from a set of cards to six player positions and to one dealer position; d) resolving the Pai Gow game and awarding bonuses to players making the second wager that have a best five-card hand that exceeds a predetermined rank; and e) awarding an additional bonus to players with hands that exceed the predetermined rank if the dealer's best five-card hand is equal to or less than a predetermined rank. An optional envy hand event may be included with the second wager or a special qualifying second or third wager.

Although Pai Gow poker has achieved a level of success where it is present in most card rooms, it is desirable to provide additional features to the game that can make it even more attractive and successful.

### SUMMARY OF THE INVENTION

A competitive playing card game is based on Pai Gow poker, except that player position playing cards are provided in two segments totaling seven random playing cards, and the dealer position receives eight random playing cards. After placing an ante and receiving a first segment of random playing cards totaling less than 7 cards, a play wager must be placed for the player position to receive additional cards to complete a seven-card hand. A player position best five-card hand poker rank (best five-of-seven playing cards) can receive payouts based on achievements against a paytable for poker ranks above a minimum threshold.

### BRIEF DESCRIPTION OF THE FIGURES

FIG. 1 shows a schematic for an electronic system for enabling play of the gaming method described herein.

FIG. 1A shows another schematic for an electronic system for enabling play of the gaming method described herein.

FIG. 1B shows an electronic gaming machine on which the gaming method may be executed.

### DETAILED DESCRIPTION OF THE INVENTION

The present technology includes a competitive playing card game (with physical playing cards or virtual playing cards provided from memory associated with a game processor) based on Pai Gow poker, the competitive playing card game or event using an initial set of playing cards (often referred to as a deck of playing cards, whether a physical set or virtual set) that includes a standard fifty-two card deck having four suits (typically Spades, Hearts, Diamonds and Clubs) and thirteen ranks (typically 2, 3, 4, 5, 6, 7, 8, 9, 10, Jack, Queen, King and Ace) and typically a Joker as a semi-wild card (which can be used only as an Ace, or a card to complete a straight or a flush with other playing cards in a hand).

The game can be described as a method of playing a Pai Gow poker competitive card game. Actions may include:
a) providing a source of random playing cards from a set of playing cards comprising a standard 52-card deck plus one wild card;
b) a dealer providing a first set of random playing cards face-down to a player position, the total number of random playing cards provided to the player position as the first set being between 1 and 6 random playing cards;
c) the dealer position providing a second set of random playing cards face-down to the dealer position, the total number of random playing cards provided to the dealer position as the second set being 8 random playing cards, dealt immediately or in segments;
d) the player position either folding play with the first set of playing cards, or accepting a sufficient number of additional random playing cards to complete a final player third set of seven random playing cards;
e) the player position forming a first 5-card poker hand rank and first 2-card poker hand rank that is lower than the first 5-card poker hand rank from the final player position set of seven playing cards;
f) the dealer position forming a second 5-card hand with a second five-card poker rank and a second 2-card poker hand rank that is lower than the second 5-card poker hand rank from the final dealer set of eight playing cards, discarding a remaining eighth card; and
g) the dealer position determining a winning hand as between the dealer position second 5-card hand and the second 2-card poker hand rank as compared to the player position first 5-card poker hand rank and first 2-card poker hand rank;
wherein winning, losing and tying to resolve the competitive card game are determined as:
dealer position wins when both dealer position hands are respectively higher poker ranks than poker ranks of both player position hands, or one dealer position hand is respectively higher poker rank than the poker rank of one respective player position hand and a remaining respective player position hand and dealer position hand tie for poker rank;
the player position wins when both player position hands are respectively higher poker ranks than the poker ranks of both respective dealer position hands, and
there is a tie when one respective player position hand is a higher poker rank than a respective dealer position hand and one respective dealer position hand is a higher poker rank than a respective player position hand.

In the method, as a wagering competition, before a player position reviews the first set of random playing cards delivered to a player position, an ante wager must be committed at the player position, and the ante wager is resolved according to the winning, losing and tying determination. The player position must commit a play wager at least equal in value to the ante wager before the player position can accept the additional number of random playing cards. The play wager may be chosen by the player position at a value of between 1 times to 4 times the value of the ante wager, preferably 1-3 times the value of the ante.

The method is preferably practiced where the first set of random playing cards at the player position includes from 2-5 random playing cards, preferably 3-4 random playing cards and most preferably four random playing cards.

The competitive event does not have to be a gaming event, but it preferably is, where a player position makes an Ante wager. The dealer receives eight (8) random playing cards face-down cards from the initial set of playing cards, leaving a first residual set of playing cards. The player position is dealt a first initial playing card hand of four random face-down cards from the first residual set of playing cards, leaving a second set of residual playing cards. The player can now bet 1×-3× to the amount of the Ante or fold after viewing and considering the first initial playing card hand. (Note, for an easily-understood short-hand description, all cards distributed to any hand at any time will be considered as and referred to as from the initial set of playing cards, even though in subsequent actions, the “initial” set has been diminished to varying degrees)

If the player position places a Play wager or additional bets, the player position receives its final three random face-down playing cards from the initial set of playing cards to complete his hand. The player now sets a 5-card high poker hand and a 2-card lower rank poker hand, as in traditional Pai Gow.

The dealer sets a 5-card high poker rank hand and 2-card lower rank poker hand. This is preferably, but not essentially done according to a standardized house method, and sets aside (discards) the 8th card.

Both of the two Dealer hands and the two player position hands (both 5-card and 2-card hands) are compared with respect to poker ranks in each hand, as is the standard procedure in Pai Gow. The Ante and the Play wager are resolved as if they constituted the standard Play wager, the single wager as used in the standard version of Pai Gow, where the player position must win both hands to win, and loses when both hands lose or one hand loses and the other hand ties. Ties occur when the player position wins one hand and the dealer position wins another of the two hands. The ante wager may be resolved against a paytable as part of the initial wager, usually based on the poker rank of the 5-card player position hand only (best five-of-seven playing cards), or a combination of poker ranks in both the 2-card player position hand and the player position 5-card hand (best five-of-seven playing cards, or the actual play of the two hands).

For example, there can be a paytable where player position poker hand ranks of at least a straight, or at least a flush are paid as odds against the ante wager (the Play wager could be used, but that offers a far greater advantage to the player position hand) for the straight or flush, and higher odds for higher poker rank hands in the player position 5-card hand (best five-of-seven playing cards).

Alternatively, in addition to requiring a minimum 5-card poker rank in the player position, there may be a requirement of at least a minimum 2-card poker hand rank, such as at least a pair, or at least a pair of a minimum rank (e.g., at least a pair of 4s, or at least a pair of 6s) in combination with a minimum 5-card poker rank at the player position. Payments may be made on only 2-card player position hands, but because of their higher frequency, the payout odds must be significantly lower. The administration of payouts against the paytable may or may not require the two player position hands to win against the two dealer position hands for the award from the paytable to be received, or the player position five-card hand (only, whether the naturally played hand or a best five-of-seven playing cards) must (or need not) exceed the dealer position five-card hand poker rank.

There may also side bets and side gaming events occurring parallel to the underlying gaming event.

There may be Optional High Hand and Dealer's 8th Card™ sidebets. There may also be event options in the execution of the gaming event. The method may be executed where cards are only dealt to players with wagers, instead of dealing 7 cards to all six players plus dealer regardless of number of players at the table. A method may be executed where a dealer programs the input device (shuffler) to deal only the required number of hands. A method may be executed where the dealer deals himself his 8-card hand first, and always deals the first set of cards (e.g., four-cards starting with the player to his left and going clockwise, rather than using dice or an input device to determine which position gets the first hand as in regular Pai Gow).

### Potential Sidebets

1. High Hand. Based on the player's best five-card hand using all seven player cards, from Straight up to 5 Aces, possibly including rarer, 7-card combinations as well.
2. Dealer's 8th Card. Based on the dealer's discard. For example, the bet may lose if the 8th card is a 2-6, pay even money for 7-9, with progressively bigger payoffs for 10, J, Q, K, A, and Joker.

### Variations For Gaming Events Referred to as Open Face Pai Gow™ and Open Face Pai Gow Pineapple™

Also possible are a number of variations, ideally where the player is dealt three initial cards and must set them face up before receiving additional cards.
1. Player Antes. Dealer receives 7 or 8 down cards to make the dealer five-card High and two-card Low hands.
2. Player is dealt three down cards, and may bet 1×-3× the Ante.
3. If the player bets, the player must set his first three cards face up.
   For example, if the player is dealt A-A-K, he would likely place the A-A in the High Hand boxes, and the K in the low hand.
4. Variation A: The player receives his final four cards, and sets his five-card High and two-card Low hands face up.
5. Variation B (Open Face Pai Gow™): The player receives a final five cards, and sets four of them to complete his five-card and two-card hands, while discarding the remaining card.
6. Variation C (Open Face Pai Gow Pineapple™): The dealer position receives eights cards to make his five-card High and two-card Low hands; the player may receive three cards, then make a final 1×-3×, 2×-4×, or 2×-5× wager, or fold. If the player bets, the player sets two cards face up and discards the third, and receives his final three cards. The player will use two of those cards to complete the player five-card and two-card hands, while discarding the final card.
7. Player vs. Player Open Face Pai Gow Pineapple™ variation (2-5 players) (intended for electronic multi-player table): No additional wagering after the Antes. Players make Ante wagers, computer randomly selects player who receives cards first and acts first, with action moving clockwise around the table. Players receive first three cards and set them face up. Version 1: Players receive next three cards, set two cards face up and discard one; players then receive final three cards, set two cards face up and discard one. Version 2: Players receive five cards, set four cards face up and discard the fifth.
1. In this variation, after the player position receives the first set of random playing cards face down (or face up), the player position must position all random playing cards received in the first set to commit each card to the player position five-card hand and the player position 2-card hand. The cards may be positioned in any manner, except that no more than two cards can be assigned to the 2-card player position hand. This play modality can force hands to be fouled (e.g., the 2-card hand could be a higher rank than the 5-card poker rank), and this would cause the player position hand to be a loss. The loss may or may not include the automatic best-five-of-seven action of the ante (or any additional side bet) against a paytable.

The gaming aspects of the competition (as with a player against the house, represented by a dealer) can be played with a standard commission (e.g., 5% on player position winning hand) or without a commission, given the dealer position increased advantage when there are eight cards in the dealer position hand, from which a final seven are chosen, and the standard seven cards in the player hand. It is preferred, as the ante wager is automatically played against a paytable, that one of two options be exercised. A first option is that the player must win the underlying wager on Pai Gow poker (winning both hands against the dealer), the natural (placed) 5-card hand beats the dealer position poker rank for the five-card rank, or the best 5-of-7 poker hand rank at the player position beats the positioned 5-card poker hand rank at the dealer position. In another version, any positioned 5-card player position hand or any best 5-of-7 player cards that form a 5-card poker hand rank that exceeds the minimum value on a paytable. That minimum value can be as low as three-of-a-king, a straight, a flush or full house, depending upon the odds provided for the minimum rank and each progressive five-card poker hand rank, up to a Royal Flush, or even five Aces (using the Joker).

The technology may be performed in various electronic modes. Turning next to FIG. I, a video gaming machine 2 of the present invention is shown. Machine 2 includes a main cabinet 4, which generally surrounds the machine interior (not shown) and is viewable by users. The main cabinet includes a main door 8 on the front of the machine, which opens to provide access to the interior of the machine. Attached to the main door are player-input switches or buttons 32, a coin acceptor 28, and a bill validator 30, a coin tray 38, and a display area including a mechanical gaming system (or less preferably a separate electronic game) 40. There may be an overlay of touchscreen functionality on the separate electronic game 40 or some of the buttons 32 may be functional on the separate mechanical gaming system 40. That separate mechanical gaming system may be in a relatively vertical viewing position as shown or in a more horizontal (table like) display unit. Viewable through the main door is a video display monitor 34 and an information panel 36. The display monitor 34 will typically be a cathode ray tube, high resolution flat-panel LCD, LED, plasma screen or other conventional electronically controlled video monitor. The information panel 36 may be a back-lit, silk screened glass panel with lettering to indicate general game information including, for example, a game denomination (e.g. $0.25 or $1). The bill validator 30, player-input switches 32, video display monitor 34, and information panel are devices used to play a game on the game machine 2. The devices are controlled by circuitry (e.g. the master craning controller) housed inside the main cabinet 4 of the machine 2.

Many different types of games, including mechanical slot games, video slot games, video poker, video black jack, video pachinko and lottery, may be provided with gaming machines of this invention. In particular, the gaming machine 2 may be operable to provide a play of many different instances of games of chance. The instances may be differentiated according to themes, sounds, graphics, type of game (e.g., slot game vs. card game), denomination, number of paylines, maximum jackpot, progressive or non-progressive, bonus games, etc. The gaming machine 2 may be operable to allow a player to select a game of chance to play from a plurality of instances available on the gaining machine. For example, the gaming machine may provide a menu with a list of the instances of games that are available for play on the gaming machine and a player may be able to select from the list a first instance of a game of chance that they wish to play.

The various instances of games available for play on the gaming machine 2 may be stored as game software on a mass storage device in the gaming machine or may be generated on a remote gaming device but then displayed on the gaming machine. The gaming machine 2 may executed game software, such as but not limited to video streaming software that allows the game to be displayed on the gaming machine. When an instance is stored on the gaming machine 2, it may be loaded from the mass storage device into a RAM for execution. In some cases, after a selection of an instance, the game software that allows the selected instance to be generated may be downloaded from a remote gaming device, such as another gaming machine.

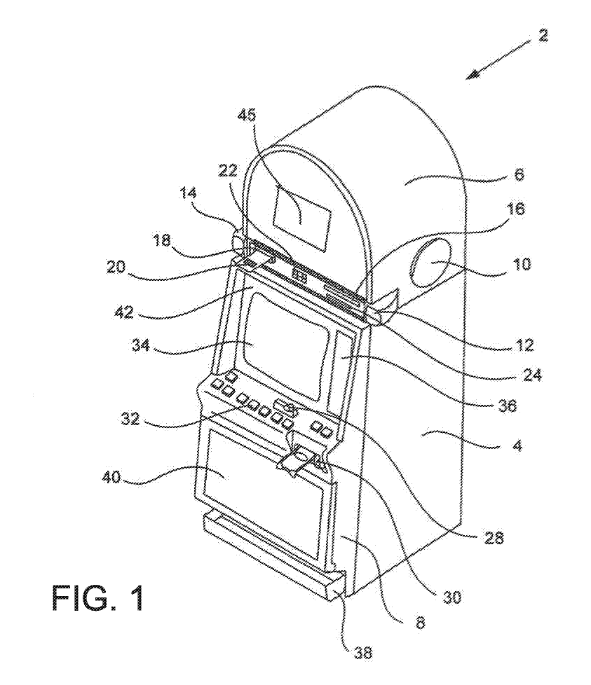

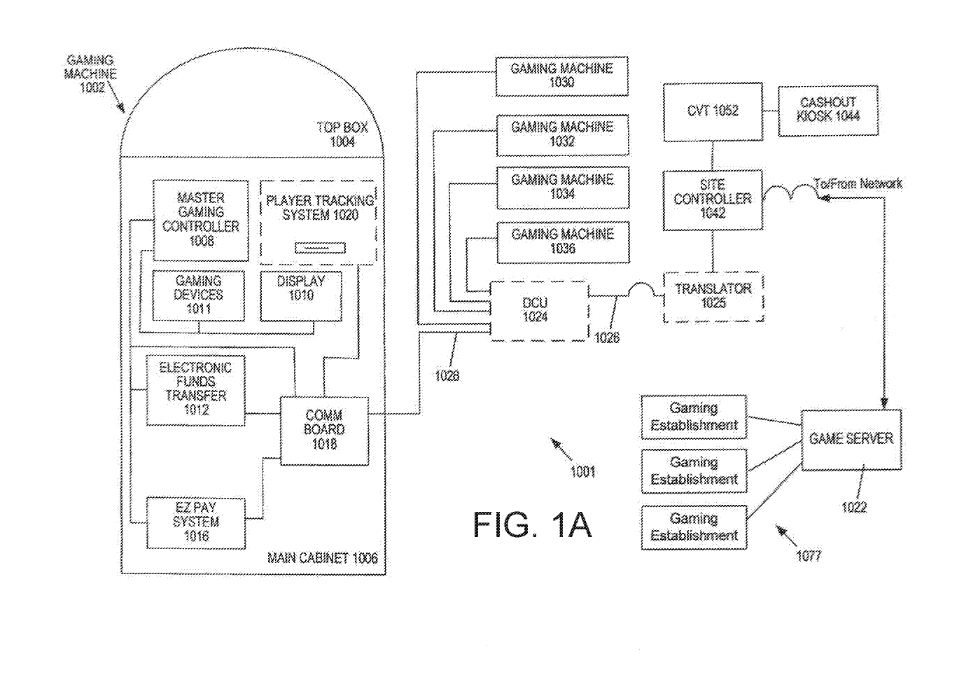

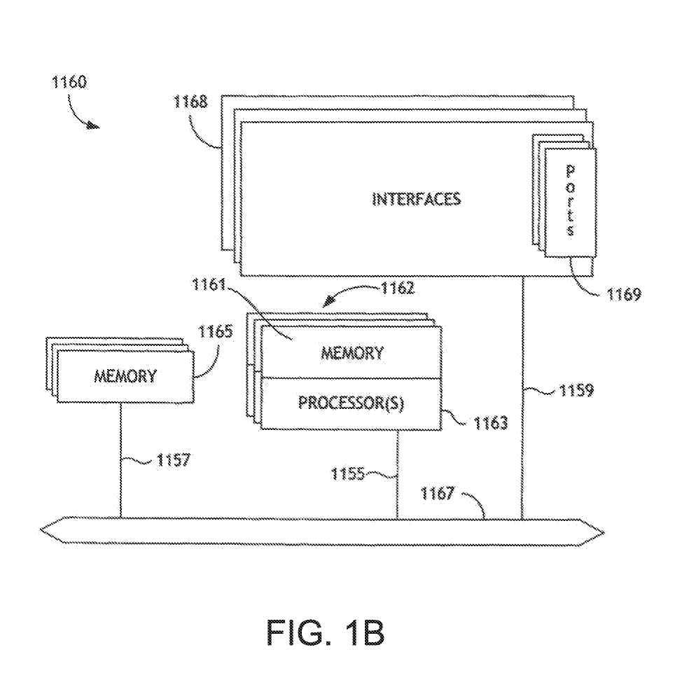

The gaming machine 2 includes a top box 6, which sits on top of the main cabinet 4. The top box 6 houses a number of devices, which may be used to add features to a game being played on the gaming machine 2, including speakers 10, 12, 14, a ticket printer 18 which prints bar-coded tickets 20, a key pad 22 for entering player tracking information, a florescent display 16 for displaying player tracking information, a card reader 24 for entering a magnetic striped card containing player tracking information, and a video display screen 42. The ticket printer 18 may be used to print tickets for a cashless ticketing system. Further, the top box 6 may house different or additional devices than shown in the FIG. 1. For example, the top box may contain a bonus wheel or a back-lit silk screened panel which may be used to add bonus features to the game being played on the gaming machine. As another example, the top box may contain a display for a progressive jackpot offered on the gaming machine. During a game, these devices are controlled and powered, in part, by circuitry (e.g. a master gaming controller) housed within the main cabinet 4 of the machine 2.

Understand that gaming machine 2 is but one example from a wide range of gaming machine designs on which the present invention may be implemented. For example, not suitable gaming machines have top boxes or player tracking features. Further, some gaming machines have only a single game display—mechanical or video, while others are designed for bar tables and have displays that face upwards. As another example, a game may be generated in on a host computer and may be displayed on a remote terminal or a remote gaming device. The remote gaming device may be connected to the host computer via a network of some type such as a local area network, a wide area network, an intranet or the Internet. The remote gaming device may be a portable gaming device such as but not limited to a cell phone, a personal digital assistant, and a wireless game player. Images rendered from 3-D gaming environments may be displayed on portable gaming devices that are used to play a game of chance. Further a gaming machine or server may include gaming logic for commanding a remote gaming device to render an image from a virtual camera in a 3-D gaming environments stored on the remote gaming device and to display the rendered image on a display located on the remote gaming device. Thus, those of skill in the art will understand that the present invention, as described below, can be deployed on most any gaming machine now available or hereafter developed.

Some preferred gaming machines are implemented with special features and/or additional circuitry that differentiates them from general-purpose computers (e.g., desktop PC's and laptops). Gaming machines are highly regulated to ensure fairness and, in many cases, gaming machines are operable to dispense monetary awards of multiple millions of dollars. Therefore, to satisfy security and regulatory requirements in a gaming environment, hardware and software architectures may be implemented in gaming machines that differ significantly from those of general-purpose computers. A description of gaming machines relative to general-purpose computing machines and some examples of the additional (or different) components and features found in gaming machines are described below.

At first glance, one might think that adapting PC technologies to the gaining industry would be a simple proposition because both PCs and gaming machines employ microprocessors that control a variety of devices. However, because of such reasons as 1) the regulatory requirements that are placed upon gaming machines, 2) the harsh environment in which gaming machines operate, 3) security requirements and 4) fault tolerance requirements, adapting PC technologies to a gaming machine can be quite difficult. Further, techniques and methods for solving a problem in the PC industry, such as device compatibility and connectivity issues, might not be adequate in the gaming environment. For instance, a fault or a weakness tolerated in a PC, such as security holes in software or frequent crashes, may not be tolerated in a gaming machine because in a gaming machine these faults can lead to a direct loss of funds from the gaming machine, such as stolen cash or loss of revenue when the gaming machine is not operating properly.

For the purposes of illustration, a few differences between PC systems and gaming systems will be described. A first difference between gaming machines and common PC based computers systems is that gaming machines are designed to be state-based systems. In a state-based system, the system stores and maintains its current state in a non-volatile memory, such that, in the event of a power failure or other malfunction the gaming machine will return to its current state when the power is restored. For instance, if a player was shown an award for a game of chance and, before the award could be provided to the player the power failed, the gaming machine, upon the restoration of power, would return to the state where the award is indicated. As anyone who has used a PC, knows, PCs are not state machines and a majority of data is usually lost when a malfunction occurs. This requirement affects the software and hardware design on a gaming machine.

A second important difference between gaming machines and common PC based computer systems is that for regulation purposes, the software on the gaming machine used to generate the game of chance and operate the gaming machine has been designed to be static and monolithic to prevent cheating by the operator of gaming machine. For instance, one solution that has been employed in the gaming industry to prevent cheating and satisfy regulatory requirements has been to manufacture a gaming machine that can use a proprietary processor running instructions to generate the game of chance from an EPROM or other form of non-volatile memory. The coding instructions on the EPROM are static (non-changeable) and must be approved by a gaming regulators in a particular jurisdiction and installed in the presence of a person representing the gaming jurisdiction. Any changes to any part of the software required to generate the game of chance, such as adding a new device driver used by the master gaming controller to operate a device during generation of the game of chance can require a new EPROM to be burnt, approved by the gaming jurisdiction and reinstalled on the gaming machine in the presence of a gaming regulator. Regardless of whether the EPROM solution is used, to gain approval in most gaming jurisdictions, a gaming machine must demonstrate sufficient safeguards that prevent an operator or player of a gaming machine from manipulating hardware and software in a manner that gives them an unfair and some cases an illegal advantage. The gaming machine should have a means to determine if the code it will execute is valid. If the code is not valid, the gaming machine must have a means to prevent the code from being executed. The code validation requirements in the gaming industry affect both hardware and software designs on gaming machines.

A third important difference between gaming machines and common PC based computer systems is the number and kinds of peripheral devices used on a gaming machine are not as great as on PC based computer systems. Traditionally, in the gaming industry, gaming machines have been relatively simple in the sense that the number of peripheral devices and the number of functions the gaming machine has been limited. Further, in operation, the functionality of gaming machines were relatively constant once the gaming machine was deployed, i.e., new peripherals devices and new gaming software were infrequently added to the gaming machine. This differs from a PC where users will go out and buy different combinations of devices and software from different manufacturers and connect them to a PC to suit their needs depending on a desired application. Therefore, the types of devices connected to a PC may vary greatly from user to user depending in their individual requirements and may vary significantly over time.

Although the variety of devices available for a PC may be greater than on a gaming machine, gaming machines still have unique device requirements that differ from a PC, such as device security requirements not usually addressed by PCs. For instance, monetary devices, such as coin dispensers, bill validators and ticket printers and computing devices that are used to govern the input and output of cash to a gaming machine have security requirements that are not typically addressed in PCs. Therefore, many PC techniques and methods developed to facilitate device connectivity and device compatibility do not address the emphasis placed on security in the gaming industry.

To address some of the issues described above, a number of hardware/software components and architectures are utilized in gaming machines that are not typically found in general purpose computing devices, such as PCs. These hardware/software components and architectures, as described below in more detail, include but are not limited to watchdog timers, voltage monitoring systems, state-based software architecture and supporting hardware, specialized communication interfaces, security monitoring and trusted memory.

A watchdog timer is normally used in gaming machines to provide a software failure detection mechanism. In a normally operating system, the operating software periodically accesses control registers in the watchdog timer subsystem to “re-trigger” the watchdog. Should the operating software fail to access the control registers within a preset timeframe, the watchdog tinier will timeout and generate a system reset. Typical watchdog timer circuits contain a loadable timeout counter register to allow the operating software to set the timeout interval within a certain range of time. A differentiating feature of the some preferred circuits is that the operating software cannot completely disable the function of the watchdog timer. In other words, the watchdog timer always functions from the time power is applied to the board.

Gaming computer platforms preferably use several power supply voltages to operate portions of the computer circuitry. These can be generated in a central power supply or locally on the computer board. If any of these voltages falls out of the tolerance limits of the circuitry they power, unpredictable operation of the computer may result. Though most modem general-purpose computers include voltage monitoring circuitry, these types of circuits only report voltage status to the operating software. Out of tolerance voltages can cause software malfunction, creating a potential uncontrolled condition in the gaming computer. Gaming machines typically have power supplies with tighter voltage margins than that required by the operating circuitry. In addition, the voltage monitoring circuitry implemented in gaming computers typically has two thresholds of control. The first threshold generates a software event that can be detected by the operating software and an error condition generated. This threshold is triggered when a power supply voltage falls out of the tolerance range of the power supply, but is still within the operating range of the circuitry. The second threshold is set when a power supply voltage falls out of the operating tolerance of the circuitry. In this case, the circuitry generates a reset, halting operation of the computer.

The standard method of operation for slot machine game software is to use a state machine. Different functions of the game (bet, play, result, points in the graphical presentation, etc.) may be defined as a state. When a game moves from one state to another, critical data regarding the game software is stored in a custom non-volatile memory subsystem. This is critical to ensure the player's wager and credits are preserved and to minimize potential disputes in the event of a malfunction on the gaming machine.

In general, the gaming machine does not advance from a first state to a second state until critical information that allows the first state to be reconstructed is stored. This feature allows the game to recover operation to the current state of play in the event of a malfunction, loss of power, etc. that occurred just prior to the malfunction. After the state of the gaming machine is restored during the play of a game of chance, game play may resume and the game may be completed in a manner that is no different than if the malfunction had not occurred. Typically, battery backed RAM devices are used to preserve this critical data although other types of non-volatile memory devices may be employed. These memory devices are not used in typical general-purpose computers.

As described in the preceding paragraph, when a malfunction occurs during a game of chance, the gaming machine may be restored to a state in the game of chance just prior to when the malfunction occurred. The restored state may include metering information and graphical information that was displayed on the gaming machine in the state prior to the malfunction. For example, when the malfunction occurs during the play of a card game after the cards have been dealt, the gaming machine may be restored with the cards that were previously displayed as part of the card game. As another example, a bonus game may be triggered during the play of a game of chance where a player is required to make a number of selections on a video display screen. When a malfunction has occurred after the player has made one or more selections, the gaming machine may be restored to a state that shows the graphical presentation at the just prior to the malfunction including an indication of selections that have already been made by the player. In general, the gaming machine may be restored to any state in a plurality of states that occur in the game of chance that occurs while the game of chance is played or to states that occur between the play of a game of chance.

Game history information regarding previous games played such as an amount wagered, the outcome of the game and so forth may also be stored in a non-volatile memory device. The information stored in the non-volatile memory may be detailed enough to reconstruct a portion of the graphical presentation that was previously presented on the gaming machine and the state of the gaming machine (e.g., credits) at the time the game of chance was played. The game history information may be utilized in the event of a dispute. For example, a player may decide that in a previous game of chance that they did not receive credit for an award that they believed they won. The game history information may be used to reconstruct the state of the gaming machine prior, during and/or after the disputed game to demonstrate whether the player was correct or not in their assertion.

Another feature of gaming machines, such as gaming computers, is that they often contain unique interfaces, including serial interfaces, to connect to specific subsystems internal and external to the slot machine. The serial devices may have electrical interface requirements that differ from the “standard” EIA 232 serial interfaces provided by general-purpose computers. These interfaces may include EIA 485, EIA 422, Fiber Optic Serial, optically coupled serial interfaces, current loop style serial interfaces, etc. In addition, to conserve serial interfaces internally in the slot machine, serial devices may be connected in a shared, daisy-chain fashion where multiple peripheral devices are connected to a single serial channel.

The serial interfaces may be used to transmit information using communication protocols that are unique to the gaming industry. For example, the Netplex™ system of IGT is a proprietary communication protocol used for serial communication between gaming devices. As another example, SAS is a communication protocol used to transmit information, such as metering information, from a gaming machine to a remote device. Often SAS is used in conjunction with a player tracking system.

Gaming machines may alternatively be treated as peripheral devices to a casino communication controller and connected in a shared daisy chain fashion to a single serial interface. In both cases, the peripheral devices are preferably assigned device addresses. If so, the serial controller circuitry must implement a method to generate or detect unique device addresses. General-purpose computer serial ports are not able to do this.

Security monitoring circuits detect intrusion into a gaming machine by monitoring security switches attached to access doors in the slot machine cabinet. Preferably, access violations result in suspension of game play and can trigger additional security operations to preserve the current state of game play. These circuits also function when power is off by use of a battery backup. In power-off operation, these circuits continue to monitor the access doors of the slot machine. When power is restored, the gaming machine can determine whether any security violations occurred while power was off, e.g., via software for reading status registers. This can trigger event log entries and further data authentication operations by the slot machine software.

Trusted memory devices are preferably included in a gaming machine computer to ensure the authenticity of the software that may be stored on less secure memory subsystems, such as mass storage devices. Trusted memory devices and controlling circuitry are typically designed to not allow modification of the code and data stored in the memory device while the memory device is installed in the slot machine. The code and data stored in these devices may include authentication algorithms, random number generators, authentication keys, operating system kernels, etc. The purpose of these trusted memory devices is to provide gaming regulatory authorities a root trusted authority within the computing environment of the slot machine that can be tracked and verified as original. This may be accomplished via removal of the trusted memory device from the slot machine computer and verification of the secure memory device contents is a separate third party verification device. Once the trusted memory device is verified as authentic, and based on the approval of the verification algorithms contained in the trusted device, the gaming machine is allowed to verify the authenticity of additional code and data that may be located in the gaming computer assembly, such as code and data stored on hard disk drives. A few details related to trusted memory devices that may be used in the present invention are described in U.S. Pat. No. 6,685,567 titled “Process Verification,” which is incorporated herein in its entirety and for all purposes.

Mass storage devices used in a general purpose computer typically allow code and data to be read from and written to the mass storage device. In a gaming machine environment, modification of the gaming code stored on a mass storage device is strictly controlled and would only be allowed under specific maintenance type events with electronic and physical enablers required. Though this level of security could be provided by software, gaming computers that include mass storage devices preferably include hardware level mass storage data protection circuitry that operates at the circuit level to monitor attempts to modify data on the mass storage device and will generate both software and hardware error triggers should a data modification be attempted without the proper electronic and physical enablers being present.

A method of hosting an underlying game or side bet wagering event during a game of tile-based play such as domino-type game may be executed on an electronic gaming machine, electronic gaming table or blended physical playing cards with electronic tile input and touchscreen. The electronic gaming machine may have a housing, player input control, video display including touchscreen sensitivity, processor, memory, and a value-in-value-out credit creation component selected from the group consisting of a) a ticket-in-ticket-out system having a ticket-reading scanner and ticket printer, and b) a currency validation system having a motor drive to advance currency past a scanner.

Returning to the example of FIG. 1, when a user wishes to play the gaming machine 2, he or she inserts cash through the coin acceptor 28 or bill validator 30. Additionally, the bill validator may accept a printed ticket voucher which may be accepted by the bill validator 30 as an indicia of credit when a cashless ticketing system is used. At the start of the game, the player may enter playing tracking information using the card reader 24, the keypad 22, and the florescent display 16. Further, other game preferences of the player playing the game may be read from a card inserted into the card reader. During the game, the player views game information using the video display 34. Other game and prize information may also be displayed in the video display screen 42 located in the top box.

During the course of a game, a player may be required to make a number of decisions, which affect the outcome of the game. For example, a player may vary his or her wager on a particular game, select a prize for a particular game selected from a prize server, or make game decisions which affect the outcome of a particular game. The player may make these choices using the player-input switches 32, the video display screen 34 or using some other device which enables a player to input information into the gaming machine. In some embodiments, the player may be able to access various game services such as concierge services and entertainment content services using the video display screen 34 and one more input devices.

During certain game events, the gaming machine 2 may display visual and auditory effects that can be perceived by the player. These effects add to the excitement of a game, which makes a player more likely to continue playing. Auditory effects include various sounds that are projected by the speakers 10, 12, 14. Visual effects include flashing lights, strobing lights or other patterns displayed from lights on the gaming machine 2 or from lights within the separate mechanical (or electronic) separately, individually wagerable gaming system 40. After the player has completed a game, the player may receive game tokens from the coin tray 38 or the ticket 20 from the printer 18, which may be used for further games or to redeem a prize. Further, the player may receive a ticket 20 for food, merchandise, or games from the printer 18.

Another gaming network that may be used to implement some aspects of the invention is depicted in FIG. 1A. Gaming establishment 1001 could be any sort of gaming establishment, such as a casino, a card room, an airport, a store, etc. In this example, gaming network 1077 includes more than one gaming establishment, all of which are networked to game server 1022.

Here, gaming machine 1002, and the other gaming machines 1030, 1032, 1034, and 1036, include a main cabinet 1006 and a top box 1004. The main cabinet 1006 houses the main gaming elements and can also house peripheral systems, such as those that utilize dedicated gaming networks. The top box 1004 may also be used to house these peripheral systems.

The master gaming controller 1008 controls the game play on the gaming machine 1002 according to instructions and/or game data from game server 1022 or stored within gaming machine 1002 and receives or sends data to various input/output devices 1011 on the gaming machine 1002. In one embodiment, master gaming controller 1008 includes processor(s) and other apparatus of the gaming machines described above. The master gaming controller 1008 may also communicate with a display 1010.

A particular gaming entity may desire to provide network gaming services that provide some operational advantage. Thus, dedicated networks may connect gaming machines to host servers that track the performance of gaming machines under the control of the entity, such as for accounting management, electronic fund transfers (EFTs), cashless ticketing, such as EZPay™, marketing management, and data tracking, such as player tracking. Therefore, master gaming controller 1008 may also communicate with EFT system 1012, EZPay™ system, and player tracking system 1020. The systems of the gaming machine 1002 communicate the data onto the network 1022 via a communication board 1018.

It will be appreciated by those of skill in the art that embodiments of the present invention could be implemented on a network with more or fewer elements than are depicted in FIG. 1A. For example, player tracking system 1020 is not a necessary feature of some implementations of the present invention. However, player tracking programs may help to sustain a game player's interest in additional game play during a visit to a gaming establishment and may entice a player to visit a gaming establishment to partake in various gaming activities. Player tracking programs provide rewards to players that typically correspond to the player's level of patronage (e.g., to the player's playing frequency and/or total amount of game plays at a given casino). Player tracking rewards may be free meals, free lodging and/or free entertainment. Player tracking information may be combined with other information that is now readily obtainable by an SBG system.

Moreover, DCU 1024 and translator 1025 are not required for all gaming establishments 1001. However, due to the sensitive nature of much of the information on a gaming network (e.g., electronic fund transfers and player tracking data) the manufacturer of a host system usually employs a particular networking language having proprietary protocols. For instance, 10-20 different companies produce player tracking host systems where each host system may use different protocols. These proprietary protocols are usually considered highly confidential and not released publicly.

Further, gaming machines are made by many different manufacturers. The communication protocols on the gaming machine are typically hard-wired into the gaming machine and each gaming machine manufacturer may utilize a different proprietary communication protocol. A gaming machine manufacturer may also produce host systems, in which case their gaming machines are compatible with their own host systems. However, in a heterogeneous gaming environment, gaming machines from different manufacturers, each with its own communication protocol, may be connected to host systems from other manufacturers, each with another communication protocol. Therefore, communication compatibility issues regarding the protocols used by the gaming machines in the system and protocols used by the host systems must be considered.

A network device that links a gaming establishment with another gaming establishment and/or a central system will sometimes be referred to herein as a “site controller.” Here, site controller 1042 provides this function for gaming is establishment 1001. Site controller 1042 is connected to a central system and/or other gaming establishments via one or more networks, which may be public or private networks. Among other things, site controller 1042 communicates with game server 1022 to obtain game data, such as ball drop data, bingo card data, etc.

In the present illustration, gaming machines 1002, 1030, 1032, 1034 and 1036 are connected to a dedicated gaming network 1022. In general, the DCU 1024 functions as an intermediary between the different gaming machines on the network 1022 and the site controller 1042. In general, the DCU 1024 receives data transmitted from the gaming machines and sends the data to the site controller 1042 over a transmission path 1026. In some instances, when the hardware interface used by the gaming machine is not compatible with site controller 1042, a translator 1025 may be used to convert serial data from the DCU 1024 to a format accepted by site controller 1042. The translator may provide this conversion service to a plurality of DCUs.

Further, in some dedicated gaming networks, the DCU 1024 can receive data transmitted from site controller 1042 for communication to the gaming machines on the gaming network. The received data may be, for example, communicated synchronously to the gaming machines on the gaming network.

Here, CVT 1052 provides cashless and cashout gaming services to the gaming machines in gaming establishment 1001. Broadly speaking, CVT 1052 authorizes and validates cashless gaming machine instruments (also referred to herein as “tickets” or “vouchers”), including but not limited to tickets for causing a gaming machine to display a game result and cash-out tickets. Moreover, CVT 1052 authorizes the exchange of a cashout ticket for cash. These processes will be described in detail below. In one example, when a player attempts to redeem a cash-out ticket for cash at cashout kiosk 1044, cash out kiosk 1044 reads validation data from the cashout ticket and transmits the validation data to CVT 1052 for validation. The tickets may be printed by gaming machines, by cashout kiosk 1044, by a stand-alone printer, by CVT 1052, etc. Some gaming establishments will not have a cashout kiosk 1044. Instead, a cashout ticket could be redeemed for cash by a cashier (e.g. of a convenience store), by a gaming machine or by a specially configured CVT.

FIG. 1B illustrates an example of a network device that may be configured for implementing some methods of the present invention. Network device 1160 includes a master central processing unit (CPU) 1162, interfaces 1168, and a bus 1167 (e.g., a PCI bus). Generally, interfaces 1168 include ports 1169 appropriate for communication with the appropriate media. In some embodiments, one or more of interfaces 1168 includes at least one independent processor and, in some instances, volatile RAM. The independent processors may be, for example, ASICs or any other appropriate processors. According to some such embodiments, these independent processors perform at least some of the functions of the logic described herein. In some embodiments, one or more of interfaces 1168 control such communications-intensive tasks as encryption, decryption, compression, decompression, packetization, media control and management. By providing separate processors for the communications-intensive tasks, interfaces 1168 allow the master microprocessor 1162 efficiently to perform other functions such as routing computations, network diagnostics, security functions, etc.

The interfaces 1168 are typically provided as interface cards (sometimes referred to as “linecards”). Generally, interfaces 1168 control the sending and receiving of data packets over the network and sometimes support other peripherals used with the network device 1160. Among the interfaces that may be provided are FC interfaces, Ethernet interfaces, frame relay interfaces, cable interfaces, DSL interfaces, token ring interfaces, and the like. In addition, various very high-speed interfaces may be provided, such as fast Ethernet interfaces, Gigabit Ethernet interfaces, ATM interfaces, HSSI interfaces, POS interfaces, FDDI interfaces, ASI interfaces, DHEI interfaces and the like.

When acting under the control of appropriate software or firmware, in some implementations of the invention CPU 1162 may be responsible for implementing specific functions associated with the functions of a desired network device. According to some embodiments, CPU 1162 accomplishes all these functions under the control of software including an operating system and any appropriate applications software.

CPU 1162 may include one or more processors 1163 such as a processor from the Motorola family of microprocessors or the MIPS family of microprocessors. In an alternative embodiment, processor 1163 is specially designed hardware for controlling the operations of network device 1160. In a specific embodiment, a memory 1161 (such as non-volatile RAM and/or ROM) also forms part of CPU 1162. However, there are many different ways in which memory could be coupled to the system. Memory block 1161 may be used for a variety of purposes such as, for example, caching and/or storing data, programming instructions, etc.

Regardless of network device's configuration, it may employ one or more memories or memory modules (such as, for example, memory block 1165) configured to store data, program instructions for the general-purpose network operations and/or other information relating to the functionality of the techniques described herein. The program instructions may control the operation of an operating system and/or one or more applications, for example.

Because such information and program instructions may be employed to implement the systems/methods described herein, the present invention relates to machine-readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media; and hardware devices that are specially configured to store and perform program instructions, such as read-only memory devices (ROM) and random access memory (RAM). The invention may also be embodied in a carrier wave traveling over an appropriate medium such as airwaves, optical lines, electric lines, etc. Examples of program instructions include both machine code, such as produced by a compiler, and files containing higher-level code that may be executed by the computer using an interpreter.

Although the system shown in FIG. 1B illustrates one specific network device of the present invention, it is by no means the only network device architecture on which the present invention can be implemented. For example, an architecture having a single processor that handles communications as well as routing computations, etc. is often used. Further, other types of interfaces and media could also be used with the network device. The communication path between interfaces may be bus based (as shown in FIG. 1B) or switch fabric based (such as a cross-bar).

Other variations may also be performed with the present technology, including on-line wagering. Side bets of various types (including envy wagers at multi-player tables), 5-card, low-poker hand ranks (as in Low Ball games) and the like may be added,

What is claimed:

1. A method of playing a Pai Gow poker competitive card game comprising:
providing a source of random playing cards from a set of playing cards comprising a standard 52-card deck plus one wild card;
a dealer providing a first set of random playing cards face-down to a player position, the total number of random playing cards provided to the player position as the first set being between 1 and 6 random playing cards;
the dealer position providing a second set of random playing cards face-down to the dealer position, the total number of random playing cards provided to the dealer position as the second set being 7 or 8 random playing cards, dealt immediately or in segments;
the player position either folding play with the first set of playing cards, or accepting a sufficient number of additional random playing cards to complete a final player third set of seven random playing cards;
the player position forming a first 5-card poker hand rank and first 2-card poker hand rank that is lower than the first 5-card poker hand rank from the final player position set of seven playing cards;
the dealer position forming a second 5-card hand with a second five-card poker rank and a second 2-card poker hand rank that is lower than the second 5-card poker hand rank from the final dealer set of 7 or 8 playing cards, discarding any remaining eighth card; and
the dealer position determining a winning hand as between the dealer position second 5-card hand and the second 2-card poker hand rank as compared to the player position first 5-card poker hand rank and first 2-card poker hand rank;
wherein winning, losing and tying are determined as:
dealer position wins when both dealer position hands are respectively higher poker ranks than poker ranks of both player position hands, or one dealer position hand is respectively higher poker rank than the poker rank of one respective player position hand and a remaining respective player position hand and dealer position hand tie for poker rank;
the player position wins when both player position hands are respectively higher poker ranks than the poker ranks of both respective dealer position hands, and
there is a tie when one respective player position hand is a higher poker rank than a respective dealer position hand and one respective dealer position hand is a higher poker rank than a respective player position hand.

2. The method of claim 1 wherein before a player position reviews the first set of random playing cards delivered to a player position, and the dealer position has received 8 random playing cards, an ante wager must be committed at the player position, and the ante wager is resolved according to the winning, losing and tying determination.

3. The method of claim 2 wherein a play wager at least equal in value to the ante wager must be placed at the player position before the player position can accept the additional number of random playing cards.

4. The method of claim 3 wherein the play wager is between 1 times to 4 times the value of the ante wager.

5. The method of claim 2 wherein the first set comprises from 2-5 random playing cards.

6. The method of claim 3 wherein the first set comprises from 2-5 random playing cards.

7. The method of claim 3 wherein the first set comprises three or four random playing cards.

8. The method of claim 3 wherein the first set consists of four random playing cards.

9. The method of claim 2 wherein, based on at least the ante wager, the player position best five-of-seven card poker hand rank is compared to a paytable, and if the player position best five-of-seven card poker hand rank has a 5-card poker rank identified in the paytable, a bonus award is paid to the player position.

10. The method of claim 3 wherein, based on at least the ante wager, the player position best five-of-seven card poker hand rank is compared to a paytable, and if the player position best five-of-seven card poker hand rank has a 5-card poker rank identified in the paytable, a bonus award is paid to the player position.

11. The method of claim 7 wherein, based on at least the ante wager, the player position best five-of-seven card poker hand rank is compared to a paytable, and if the player position best five-of-seven card poker hand rank has a 5-card poker rank identified in the paytable, a bonus award is paid to the player position.

12. The method of claim 8 wherein, based on at least the ante wager, the player position best five-of-seven card poker hand rank is compared to a paytable, and if the player position best five-of-seven card poker hand rank has a 5-card poker rank identified in the paytable, a bonus award is paid to the player position.

13. The method of claim 2 executed on an electronic gaming machine, wherein the dealer position is administered by a game processor in a housing with a video display, player input controls and a value-in-value-out control for receiving value to be used as credit for all wagers, all playing cards comprising randomly selected virtual playing cards, the value-in-value-out control in communication with the game processor selected from the group consisting of a currency validator with a motor drive, a ticket-in-ticket-out system including ticket scanner and ticket printer, and a near-field transmitter receiver accessing broadcast near-field transmission.

14. The method of claim 2 executed on an electronic gaming machine, wherein the dealer position is administered by a game processor in a housing with a video display, player input controls and a value-in-value-out control for receiving value to be used as credit for all wagers, all playing cards comprising randomly selected virtual playing cards, the value-in-value-out control in communication with the game processor selected from the group consisting of a currency validator with a motor drive, a ticket-in-ticket-out system including ticket scanner and ticket printer, and a near-field transmitter receiver accessing broadcast near-field transmission.

15. The method of claim 5 executed on an electronic gaming machine, wherein the dealer position is administered by a game processor in a housing with a video display, player input controls and a value-in-value-out control for receiving value to be used as credit for all wagers, all playing cards comprising randomly selected virtual playing cards, the value-in-value-out control in communication with the game processor selected from the group consisting of a currency validator with a motor drive, a ticket-in-ticket-out system including ticket scanner and ticket printer, and a near-field transmitter receiver accessing broadcast near-field transmission.

16. The method of claim 7 executed on an electronic gaming machine, wherein the dealer position is administered by a game processor in a housing with a video display, player input controls and a value-in-value-out control for receiving value to be used as credit for all wagers, all playing cards comprising randomly selected virtual playing cards, the value-in-value-out control in communication with the game processor selected from the group consisting of a currency validator with a motor drive, a ticket-in-ticket-out system including ticket scanner and ticket printer, and a near-field transmitter receiver accessing broadcast near-field transmission.

17. The method of claim 10 executed on an electronic gaming machine, wherein the dealer position is administered by a game processor in a housing with a video display, player input controls and a value-in-value-out control for receiving value to be used as credit for all wagers, all playing cards comprising randomly selected virtual playing cards, the value-in-value-out control in communication with the game processor selected from the group consisting of a currency validator with a motor drive, a ticket-in-ticket-out system including ticket scanner and ticket printer, and a near-field transmitter receiver accessing broadcast near-field transmission.

18. The method of claim 11 executed on an electronic gaming machine, wherein the dealer position is administered by a game processor in a housing with a video display, player input controls and a value-in-value-out control for receiving value to be used as credit for all wagers, all playing cards comprising randomly selected virtual playing cards, the value-in-value-out control in communication with the game processor selected from the group consisting of a currency validator with a motor drive, a ticket-in-ticket-out system including ticket scanner and ticket printer, and a near-field transmitter receiver accessing broadcast near-field transmission.

19. The method of claim 12 executed on an electronic gaming machine, wherein the dealer position is administered by a game processor in a housing with a video display, player input controls and a value-in-value-out control for receiving value to be used as credit for all wagers, all playing cards comprising randomly selected virtual playing cards, the value-in-value-out control in communication with the game processor selected from the group consisting of a currency validator with a motor drive, a ticket-in-ticket-out system including ticket scanner and ticket printer, and a near-field transmitter receiver accessing broadcast near-field transmission.

20. The method of claim 2 wherein after the player position receives the first set of random playing cards face down, the player position must position all random playing cards received in the first set to commit each card to the player position five-card hand and the player position 2-card hand.
